(19) United States
(12) Patent Application Publication
(10) Pub. No.: US 2013/0069833 A1
(43) Pub. Date: Mar. 21, 2013

(54) SMALL DEPLOYABLE UHF CIRCULARLY-POLARIZED CROSSED DIPOLE ANTENNA

(71) Applicant: Wendy Louise Lippincott, Annandale, VA (US)

(72) Inventor: Wendy Louise Lippincott, Annandale, VA (US)

(21) Appl. No.: 13/238,608

(22) Filed: Sep. 21, 2011

(51) Int. Cl. H01Q 1/28; H01Q 1/08; H01Q 21/24

(52) U.S. Cl. 343/711; 343/844

(57) ABSTRACT

A small satellite-deployable antenna includes a half-wavelength box-shaped structure having a top conducting surface, a bottom conducting surface, and a non-conducting layer positioned between the top and bottom surfaces, and four tilted crossed quarter-wavelength dipoles positioned on the top surface, each having an antenna element attached thereto and spaced about a quarter wavelength apart with respective phases of about 0°, 90°, 180°, 270°. The antenna when deployed has its small ground plane isolated from the rest of the satellite structure, thereby enabling it to direct the circularly polarized radiation in a pattern ideal for ground coverage.

### FIELD OF THE INVENTION

The invention is directed to a crossed dipole antenna, and more particularly, to such an antenna with four tilted crossed dipoles mutually spaced about a quarter wavelength apart and having a configuration readily deployable on a nano-satellite or other small satellite.

### BACKGROUND OF THE INVENTION

In the past, most satellites were larger than 1 m in dimension. Advances in electronics have initiated a whole new class of satellites called nano-satellites or small-sats. This size reduction has made it harder to fit antennas on them. Finding UHF antennas for small sats (less than 0.3 m in size) is difficult because most antennas have dimensions on the order of ½ wavelength (0.4 m for UHF at 400 MHz). Circularly polarization (CP) is preferred, and often the tight launch requirements dictate a deployable or small conformal antenna. Deployment of a complicated antenna design can be enormously expensive and risky. This is counter to the whole preference for small satellites, which relies on the tenets of “cheaper, faster, smarter”. For these reasons a new antenna design was needed.

Deployable monopoles are one of the few options for small satellites but they have linear polarization. Because of Faraday rotation (which increases at lower frequencies), for linear polarization the signal from the ground if circular will lose 3 dB, and if linear will be lost half the time due to polarization mismatch. At 400 MHz with a wavelength of 0.75 m, a circularly polarized patch with a needed ground plane is ˜0.5 m wide. Helices and quadrifilars are, also, too large and will have tricky deployments and correspondingly high costs. One solution is crossed dipoles placed on the satellite edges away from the earth. The pattern ‘wraps’ around the small structure and gives a suitable CP pattern. However, this design can be problematic if there are other deployed elements (such as solar panels), which block the view, or if the structure is actually a payload on a host vehicle.

It is therefore desirable to provide a small deployable antenna without these deficiencies.

### BRIEF SUMMARY OF THE INVENTION

According to the invention, a small satellite-deployable antenna includes a half-wavelength box-shaped structure having a top conducting surface, a bottom conducting surface, and a non-conducting layer positioned between the top and bottom surfaces, and four tilted crossed quarter-wavelength dipoles positioned on the top surface, each having an antenna element attached thereto and spaced about a quarter wavelength apart with respective phases of about 0°, 90°, 180°, 270°.

The antenna has the unique feature of isolating its small ground plane from the rest of the satellite structure, thereby enabling it to direct the circularly polarized radiation in a pattern ideal for ground coverage. The new antenna is easily deployable with a smaller un-deployed ‘footprint’ and has a wider bandwidth than the quadrifilar helix and other designs. It fits on a much smaller ground plane than a patch antenna, has a wider bandwidth, and also a pattern optimized for ground coverage of a satellite (with the most power out at the horizon, or ˜70 deg. from nadir, for low earth orbit). Another advantage of the antenna is that its four separate elements act as a distributed source and help reduce multipath from other nearby structures in the field of view such as solar panels or other antennas.

### BRIEF DESCRIPTION OF THE DRAWINGS

FIGS. 1A-B are perspective views of an antenna according to the invention;

FIGS. 2A-B are cross-sectional views of an antenna according to the invention;

FIGS. 3A-C shows the radiation patterns of an antenna according to the invention with and without the plastic insulation;

FIG. 4 is a perspective view of an antenna according to the invention with a variable line-length cable network with SMA splitters;

FIG. 5 is a graph showing the VSWR of an antenna according to the invention; and

FIGS. 6A-B show chamber test results comparing two embodiments of antennas according to the invention.

### DETAILED DESCRIPTION OF THE INVENTION

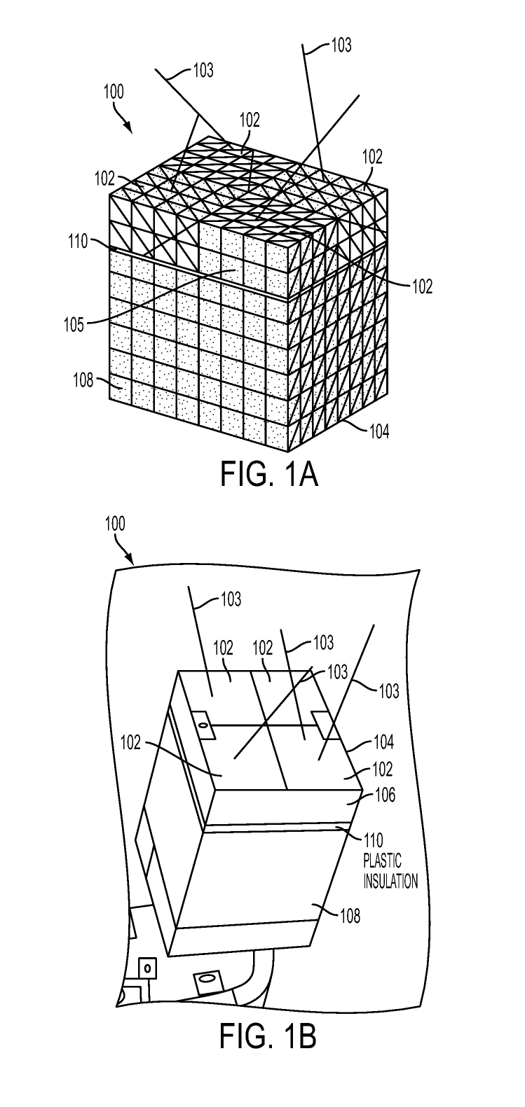

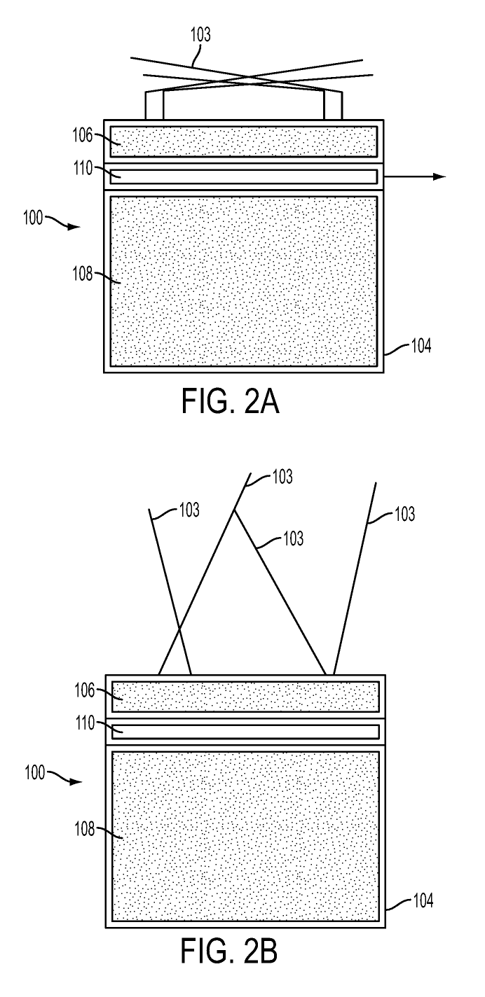

Referring now to FIGS. 1A-B, an antenna 100 according to the invention includes four tilted crossed quarter-wavelength dipoles 102, each having an antenna element 103 and spaced about a quarter wavelength apart and phased 0°, 90°, 180°, 270°, are positioned on a half-wavelength box-shaped structure 104 having a top conducting surface 106 and a bottom conducting surface 108 separated by a non-conducting layer 110 such as a ring of Delrin plastic, the position of which relative to surfaces 106 and 108 (i.e. its relative distance from each) affects the shape of the CP radiation pattern of antenna 100. Antenna element 103 is preferably a conducting material having a shape memory and superelasticity such as Nitinol so that element 103 can be stowed in a folded-down position as shown in FIG. 2A (e.g. using some type of twine as a securing means) and then upon deployment being released (the twine or other securing means being cut or otherwise removed) to recover as shown in FIG. 2B so that it then extends outwardly from surface 104 for optimal performance.

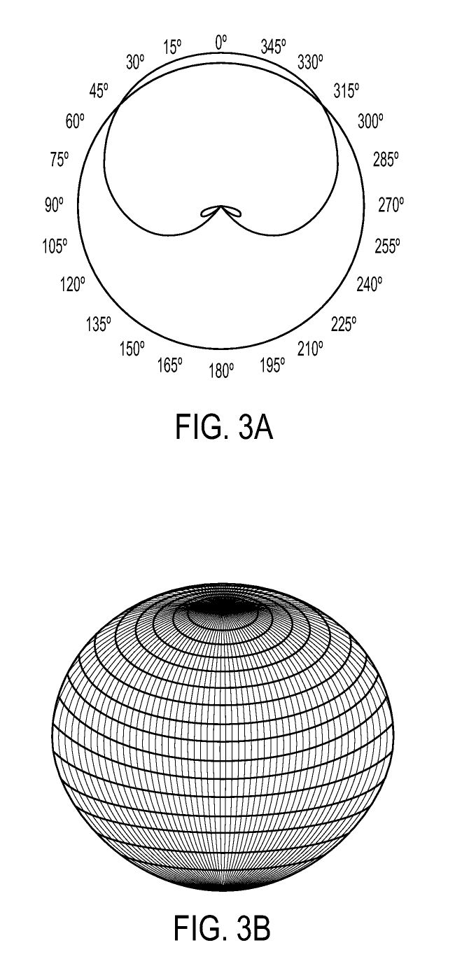

A prototype antenna 100 was built and tested in a 45 foot far-field anechoic chamber. It was found that the VSWR was very sensitive to the proximity of the four elements 103. Tilting the elements down and away from each other did not impact the pattern much but insured a very low VSWR with minimal tuning. Pattern changes with changes in the plastic ring location were much more pronounced for the prototype than for the modeling. FIGS. 3A-C show the modeling results with and without the plastic insulation. Without the insulation, the pattern ‘wraps’ around the box and is directed behind it.

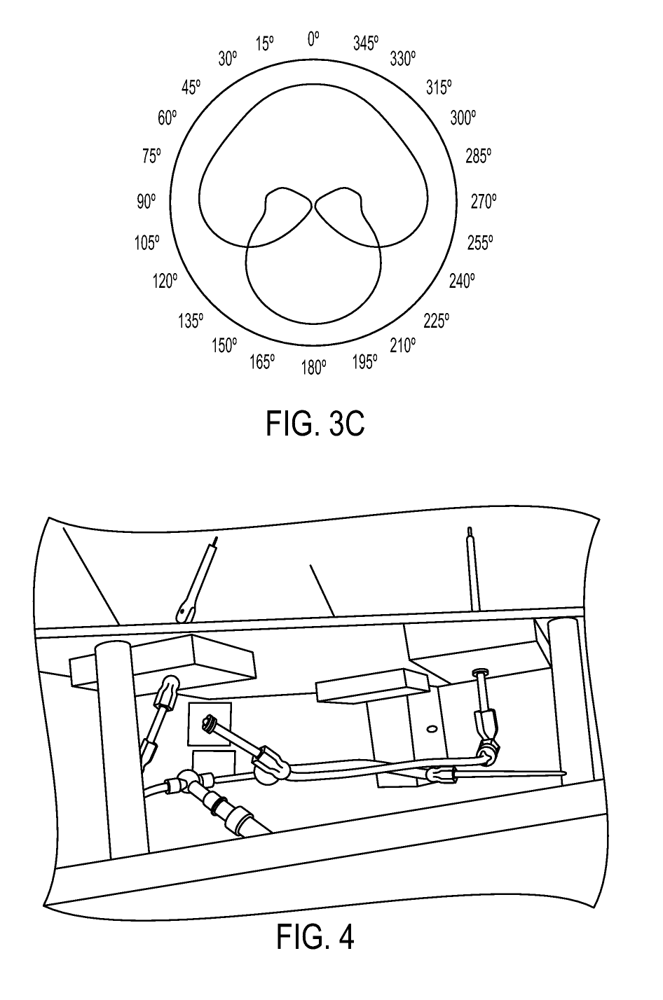

As shown in FIG. 4, a variable line-length cable network with SMA splitters was used to feed the antenna and generate the 0°, 90°, 180°, 270° phases). To determine the correct lengths of cable, a signal generator was used to feed the elements and an oscilloscope used to read the relative phases. These corresponded well with the phases estimated from the cable electrical length. A magnetic bead attached to the cable feed was used λ/4 away from the cable network input as a quarter wave transformer to reduce the VSWR. An alternative was to use a high quality SMA splitter. Another method of ‘tuning’ the antenna is to solder small ˜0.5 cm long, ˜0.4 cm diameter copper caps to the ends of the Nitinol wires. This widens the bandwidth while still maintaining the same deployability. It, also, aids in holding down the elements in stow mode, since otherwise the string can slip off the element ends. The antenna was built onto a plate with SMA bulkhead adapters which then could be bolted onto the bottom of the satellite top plate (with appropriate feed through holes). This enabled the antenna design and testing to be done with a prototype satellite structure and then later transferred to the final satellite structure with no disconnecting of cables and retesting. Several trade studies were done changing various parameters to optimize the antenna design. Most showed little sensitivity to the overall performance. Table 1 shows these results.

TABLE 1
Antenna Optimization

| Parameter | Units | Range | Method | Final | Sensitivity |
|---|---|---|---|---|---|
| Dist. between Elements | inches | 4-6 | Test | 5 | Low |
| Element Length | inches | 6-8 | Model | 7 | Medium |
| | | | | | Low |
| Element Tilt (theta) | deg. | 10-50 | Test & | 40 | Low |
| | | | Model | | |
| Element Rotation (phi) | deg. | 10-50 | Test & | 40 | Low |
| | | | Model | | |
| Center Freq. | MHz | 385-410 | Model | 400 | Medium |
| | | | | | Low |
| Phase Errors | deg. | +/−20° | Model | 0° | Medium |
| | | | | | Low |
| Ht. above Plastic Ring | inches | 0.3-3 | Test & | .3-2 | High |
| | | | Model | | |

The distance between the elements and element rotation (outward) and tilt had little effect on the pattern but greatly affected the VSWR. Keeping the elements as far apart as possible was key to a low VSWR. The distance between the elements was also limited by the cable length generating a 90 deg. phase, and 5 inches (12.7 cm) turned out to be optimum. A 45 deg. tilt and outward rotation was, also, found to be near optimum, and this helped simplify the mechanical design since there are easily obtainable SMA 45 deg. adapters for the tilt. This eliminates any confusion as to which way the angles of tilt and rotation are measured. The Nitinol element length was used to tune the VSWR and was close to λ/4 wavelengths. The design was relatively insensitive to phase errors from discrete cable lengths and phase changes with frequency. Thermal changes in the cable even with the large thermal gradients in space were calculated to be only tenths of a degree due to the short lengths relative to wavelength.

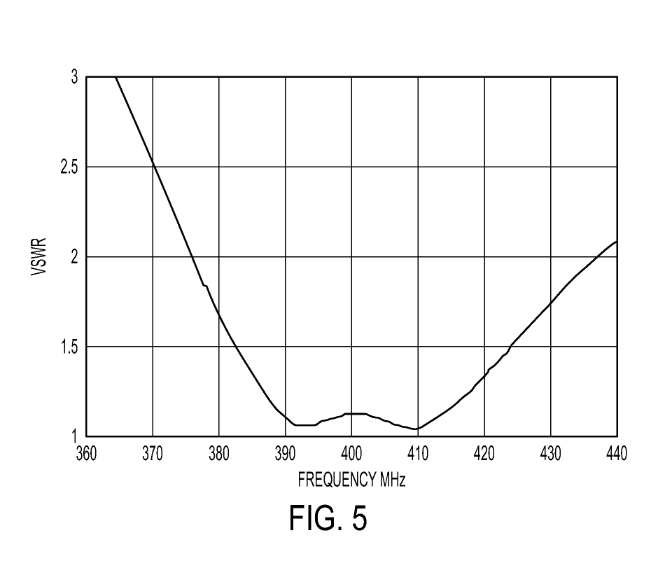

The VSWR, shown in FIG. 5, shows a 2:1 bandwidth of 370-425 MHz (14%), higher than the typical bandwidths of a patch (5%) or quadrifilar (4%).

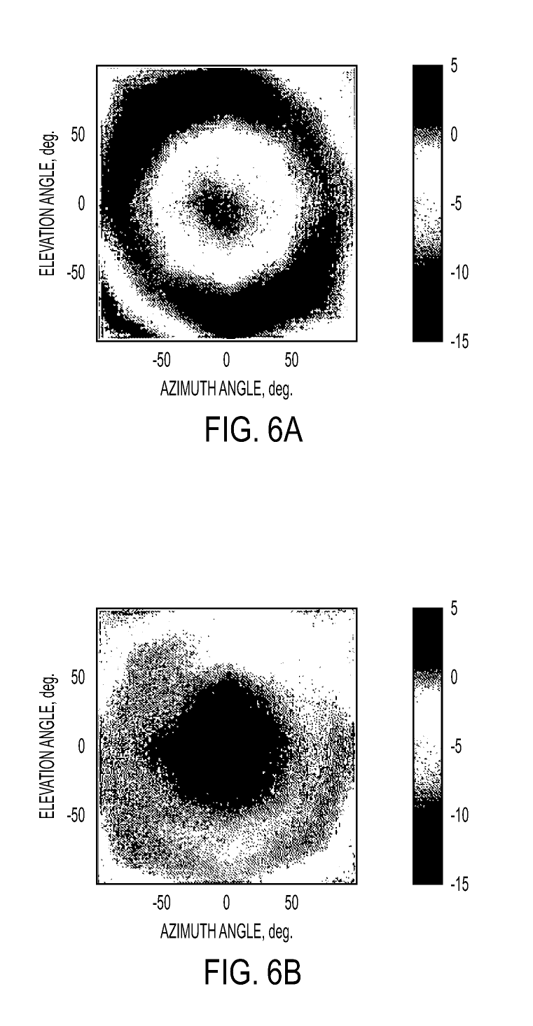

The most sensitive aspect of the design is by far the effective ground plane size. The modeling demonstrated this, but was not completely accurate in predicting the actual patterns. Since this was critical, the prototype was built to check this out and determine the optimum placement of the plastic insulating ring. FIGS. 6A-B show chamber test results from two cases where the ring was changed from 2″ optimizes below to 1″ below the top plate. The pattern changes from omni to annular. The annular pattern, left, the link at the horizon for a LEO (low earth orbit) (300-500 km height) satellite while maintaining gain closer to nadir due to the lessened space loss. The omni pattern, right, is better for a tight link margin, as was our case, to insure that the satellite will close the link at some elevation angle (since the link will improve closer to nadir).

Obviously many modifications and variations of the present invention are possible in the light of the above teachings. It is therefore to be understood that the scope of the invention should be determined by referring to the following appended claims.

what is claimed as new and desired to be protected by Letters Patent of the United States is:

1. An antenna comprising:
a half-wavelength box-shaped structure having a top conducting surface, a bottom conducting surface, and a non-conducting layer positioned between the top and bottom surfaces; and
four tilted crossed quarter-wavelength dipoles positioned on the top surface, each having an antenna element attached thereto and spaced about a quarter wavelength apart with respective phases of about 0°, 90°, 180°, 270°.

2. The antenna of claim 1, wherein each antenna element comprises a material having a shape memory and superelasticity such that each element can be stowed in a folded-down position and upon deployment recover to an extended position.

3. The antenna of claim 1, wherein each antenna element is tilted in a direction away from each other antenna element.

4. A method of launching and deploying an antenna on a nanosatellite, comprising:
positioning the antenna on the nanosatellite, wherein the antenna comprises a) a half-wavelength box-shaped structure having a top conducting surface, a bottom conducting surface, and a non-conducting layer positioned between the top and bottom surfaces; and
b) four tilted crossed quarter-wavelength dipoles positioned on the top surface, each having an antenna element attached thereto and spaced about a quarter wavelength apart with respective phases of about 0°, 90°, 180°, 270°, and wherein each antenna element comprises a material having a shape memory and superelasticity and is initially stowed in a folded-down position;
launching the nanosatellite into a desired orbit; and
deploying each antenna element from its stowed position into an extended position in order to obtain an optimized antenna performance.

5. The method of claim 4, wherein each antenna element in its deployed extended position is tilted in a direction away from each other antenna element.
